(19) United States
(12) Patent Application Publication
(10) Pub. No.: US 2015/0116360 A1
(43) Pub. Date: Apr. 30, 2015

(54) Generating A Viewpoint On a Digital Map For a Point of Interest

(71) Applicants: Jonah Jones, Darlinghurst (AU); Andrew Ofstad, San Francisco, CA (US)

(72) Inventors: Jonah Jones, Darlinghurst (AU); Andrew Ofstad, San Francisco, CA (US)

(73) Assignee: GOOGLE INC., Mountain View, CA (US)

(21) Appl. No.: 13/551,367

(22) Filed: Jul. 17, 2012

(51) Int. Cl. G09G 5/377; G06K 9/62; G06T 11/60

(52) U.S. Cl. CPC G06K 9/6202; G06T 11/60; G06K 9/6218
USPC 345/634; 345/629

(57) ABSTRACT

A point of interest (POI) viewpoint generation system and method may analyze attributes of photographs captured in the vicinity of a POI to automatically annotate a digital map with a viewpoint marker that corresponds to the POI. The viewpoint may include a geographic location in the vicinity of a POI which serves as a vantage point from where an observer (e.g., a photographer, a person viewing the location, etc.) may view or photograph the POI. The viewpoint marker may include a visible indication (e.g., an icon) included with the visual representation of the digital map. The geographic location of the viewpoint marker may roughly correspond to the cartographic location of the viewpoint.

### FIELD OF DISCLOSURE

This disclosure generally relates to techniques for annotating digital maps, and in particular, to identifying viewpoints in the vicinity of a point of interest based on analyzing photographs captured in the vicinity of the point of interest.

### BACKGROUND

A point of interest (POI) may be, for example, a landmark structure or a monument, a natural structure, a vista, etc. People often visit, view and photograph POIs. Consequently, a POI is frequently a destination on a tourist's itinerary. Traditionally, people have relied on paper maps to direct them to a POI. In some cases, symbols on the maps at the location of a POI indicate the presence of a POI. Because paper maps represent a single point in time, paper maps may become outdated with the passage of time. A person relying on a paper map to locate POI in a geographic location may have to buy a more recent map to determine if a POI still exists or to discover new POIs.

Increasingly, people carry smart phones or other devices equipped with GPS receivers. These devices may also include navigation systems that are adapted to operate with the GPS receivers. An individual may utilize the navigation system to visually locate his or her position on a digital map displayed on a GPS receiver equipped device. Frequently, the devices or navigation systems may include a database of POIs and the geographic locations of the POIs. The individual may utilize the database of POIs to get driving or walking directions to the various POIs from the individual's current location or from a configurable starting point.

A person located at approximately the geographic location of a POI may not be able to visually appreciate the POI. This person may position himself at a “viewpoint” which is at some distance away from the POI in order to view the POI. However, not all viewpoints offer the same view or perspective of a POI. Additionally, some viewpoints may allow a more dramatic view or a less impressive view of the POI during certain times of the day, or under certain weather conditions, phases of the moon, seasons, etc. For example, a natural structure such as a mountain peak may be enshrouded in fog or clouds during certain periods of the day. It would therefore not be desirable to arrive at a viewpoint to view and photograph the mountain peak during those periods of the day.

Separately, a viewpoint may fall out of favor because a newly available viewpoint offers a more dramatic view of the POI. For example, a perspective of a POI previously obscured by other structures may now be visible because the obscuring structures have been demolished. Consequently, users may increasingly choose to view and photograph the POI from a new viewpoint that allows users to see the new perspective in lieu of viewing the POI from the previous viewpoints.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In one embodiment, a computer-implemented method may annotate digital map data via a computer network. The method may receive, via the computer network, a plurality of digital photographs. Each received digital photograph may include subject data and location data. The subject data may include a digital representation of an image corresponding to a point of interest (POI) and the location data may correspond to a geographic location of a computing device that captured the image. The method may also identify a set of the plurality of digital photographs, wherein each digital photograph of the set includes an identical POI represented by the subject data for each digital photograph of the set. The method may then identify a cluster of digital photographs within the set of digital photographs. Each digital photograph of the cluster may include location data corresponding to a viewpoint cartographic location having a position on the digital map within a threshold proximity of all other photographs of the cluster. The threshold proximity may correspond to a point on the digital map indicating an average distance between each digital photograph of the cluster. The method may also annotate the digital map data with a viewpoint icon at a viewpoint cartographic location. The viewpoint cartographic location may approximately correspond to a position on the digital map within the threshold proximity of the location data for all the digital photographs of the cluster.

In another embodiment, a tangible computer-readable medium may store instructions thereon for automatically annotating digital map data. The instructions, when executed on a processor, cause the processor to receive, via the computer network, a plurality of digital photographs. Each received photograph may include subject data including a digital representation of an image corresponding to one or more physical objects. Each received photograph may also include location data corresponding to a geographic location of a computing device that captured the image. The instructions may also cause the processor to determine a point of interest (POI) for each received photograph based on the subject data and determine a set of the plurality of digital photographs. Each digital photograph of the set may include an identical POI represented by the subject data for each digital photograph of the set. The instructions may still further cause the processor to identify a cluster of digital photographs within the set of digital photographs. Each digital photograph of the cluster may include location data within a threshold proximity of all other photographs of the cluster. The instructions may also cause the processor to annotate the digital map data with a viewpoint icon at a viewpoint cartographic location. The viewpoint cartographic location may approximately correspond to a position on the digital map within the threshold proximity of the location data for all the digital photographs of the cluster.

In another embodiment, a computer system may annotate digital map data with a viewpoint icon based on analyzing a plurality of digital photographs received via a computer network. Each received digital photograph may include subject data and location data, the subject data including a digital representation of an image corresponding to one or more physical objects, and the location data for a photographer location of the digital photograph. A point of interest (POI) identification system may include instructions to determine a point of interest (POI) for each digital photograph based on the subject data and to identify a set of the plurality of digital photographs. Each digital photograph of the set may include an identical POI represented by the subject data for each digital photograph of the set. A cluster identification system may include instructions to identify a cluster of digital photographs from the set of the plurality of digital photographs. Each digital photograph of the cluster may include location data within a threshold proximity of all other photographs of the cluster. An annotation system may include instructions to annotate the digital map data with a viewpoint icon at a viewpoint cartographic location. The viewpoint cartographic location may approximately correspond to a position on the digital map within the threshold proximity of the location data for all the digital photographs of the cluster.

### BRIEF DESCRIPTION OF THE DRAWINGS

FIG. 1A is a block diagram of an example communication network in which a viewpoint generation engine operates to annotate the digital map depicted in FIG. 1 with viewpoint markers;

FIG. 1B is an illustration of example data structures that may be utilized by an example viewpoint generation system to store photographs uploaded by subscribers of photo sharing websites;

FIG. 1C is an illustration of a digital map annotated by an example viewpoint generation system with several viewpoint markers corresponding to several POI;

FIG. 2 is an illustration of example data structures that may be utilized by an example viewpoint generation engine to annotate a digital map with viewpoint markers;

FIG. 3 is an example of a block diagram of a computing device in which an example viewpoint generation engine may operate;

FIG. 4 is a flow diagram of an example method for annotating a digital map with a viewpoint marker that may be implemented in the system of FIG. 1A; and

FIG. 5 is a flow diagram of an example method for updating a viewpoint marker annotating a digital map that may be implemented in the system of FIG. 1A.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A point of interest (POI) viewpoint generation system and method may analyze attributes of photographs captured in the vicinity of a POI to automatically annotate a digital map with one or more viewpoint markers that correspond to the POI. The term “viewpoint” corresponds to a geographic location in the vicinity of a POI which serves as a vantage point from where an observer (e.g., a photographer, a person viewing the location, etc.) may view or photograph the POI. A viewpoint marker may correspond to a visible indication (e.g., an icon) that may be included with the visual representation of the digital map. The geographic location of the viewpoint marker corresponds to the cartographic location of the viewpoint.

Users of photo sharing websites may upload photographs of famous landmarks or vistas and Points of Interest (POI). After or while uploading a photograph, a user may add geographic location data to the photograph data. The geographic location data may approximately correspond to the camera's location at the time of photograph capture. Alternatively, if a user captured the photograph with a camera equipped with a GPS receiver, the metadata fields of the photograph may include time and geographic location information that corresponds to the approximate location of the camera when the photograph was captured. Systems may also access a subscriber's time-based location information from mapping and social networking applications to annotate photograph data. By correlating the capture time with a time from the subscriber's time-based location information, the system may infer the approximate location of the camera at the time of photograph capture.

As users increasingly utilize these photo sharing systems, digital maps of POI may include an ever increasing number of photographs. However, not all locations in the vicinity of a POI provide the same visual impact. Some POI are better suited to serve as vantage points to capture a photograph. Several factors may influence subscribers' selection of a particular location as a vantage point around a POI including, but not limited to, the lighting conditions at the particular time, the backdrop provided by the surroundings, the season, etc. By analyzing the clustering of photographs in the vicinity of the POI, it may be possible to determine the best viewpoints for capturing a photograph or even viewing a POI. A system may rank the several viewpoints that have been determined and annotate the map with a viewpoint marker or other icon. The system may link the viewpoints with all the photographs captured and associated with the location corresponding to the viewpoint.

A digital mapping system may display two-dimensional maps as a collection of tiles having a uniform size and including various graphical components. Because the appearance of a large number of graphical components within the tiles may clutter or confuse a user, the mapping system may selectively display subsets of these graphical components as layers within a displayed map. One layer of the map tiles may include viewpoint markers. A user may enable or disable the rendering and display of these viewpoint markers. Interacting with the marker may cause the system to display photographs associated with the view point marker. A user may also select the viewpoint marker as the destination point while navigating to the POI, so as to quickly reach the best viewpoint to view or capture a photograph of the POI. The system may also re-rank the viewpoint markers based on a number of photographs associated with the particular viewpoint markers or based on user “check-ins” and other metrics.

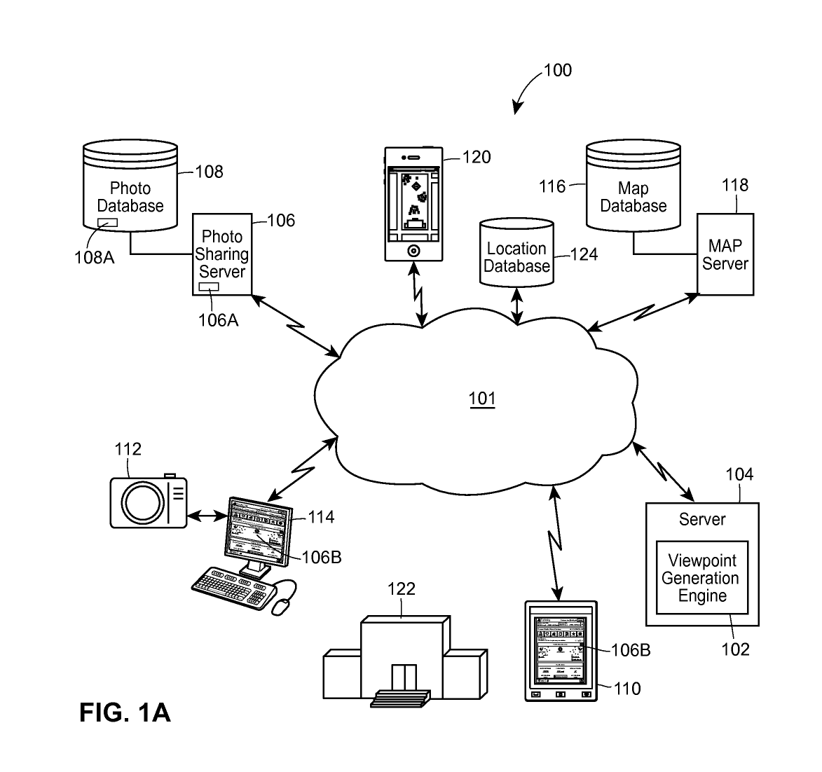

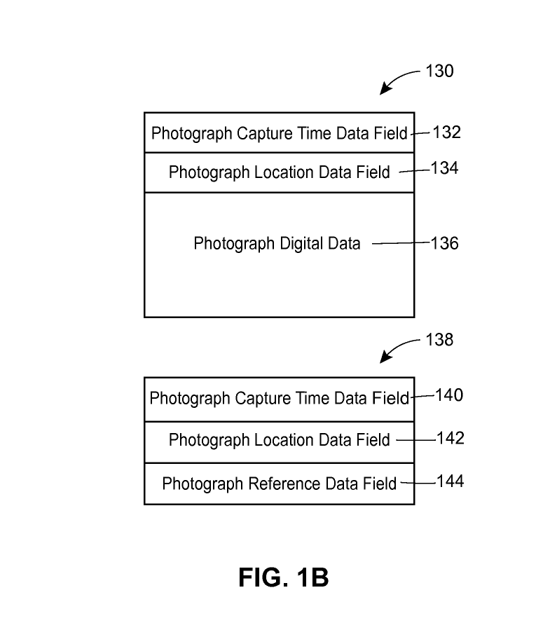

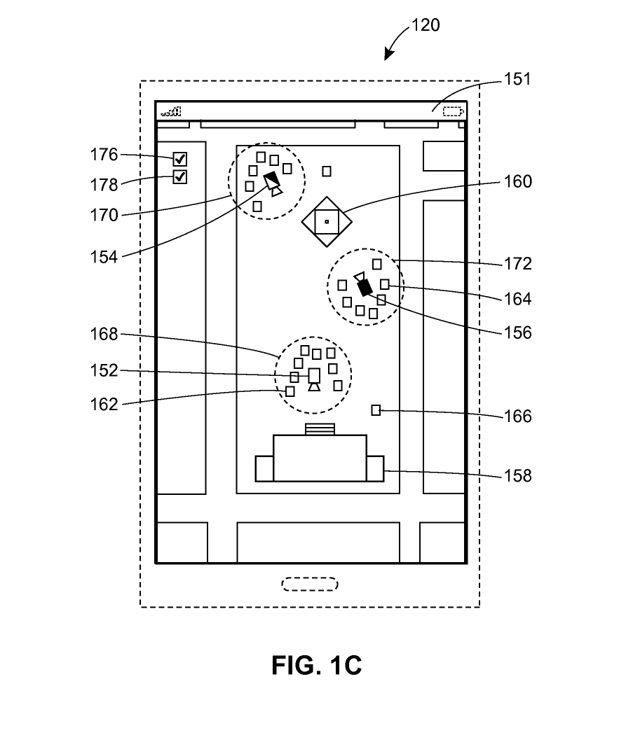

FIG. 1A illustrates an example computing environment that may implement a viewpoint generation system 100. The viewpoint generation system 100 may include a server 104 including a processor and memory storing instructions of a viewpoint generation engine 102. The instructions may include a series of computer-executable instructions stored on a computer-readable medium such as a disk, for example, and executable by the processor. By way of example and without limitation, FIG. 1A refers to the POI 122 as the subject of photographs utilized in the identification of viewpoints for the POI 122.

A photo sharing service 106A on a photo sharing server 106 may receive photographs captured by subscribers of the photo sharing service 106A via the communication network 101. The photo sharing service 106A may include instructions that cause the processor of the photo sharing server 106 to store the photographs, 108A for example, in a photo database 108. A subscriber may capture a photograph 108A that includes the POI 122 as the subject, using a GPS-receiver-equipped computing device 110. The metadata associated with the captured photograph may include information corresponding to the approximate geographic location of the computing device 110 when the subscriber captured the photograph (e.g., GPS coordinates, triangulation data, etc.) and/or a corresponding time. The subscriber may then cause the photo sharing web page 106B executing on the computing device 110 to execute an instruction to upload the photograph to the photo sharing service 106A via the communication network 101. In one embodiment, the photo sharing webpage 106B may be stored at the photo sharing server 106 as HTML code. The photo sharing webpage 106B may communicate with the photo sharing service 106A via the network 101. Subscribers of photo sharing websites may also capture photographs of the POI 122 with a GPS receiver-equipped computing device 112. The subscribers may also transfer captured photographs to a computer 114. For example, the photo sharing service 106A executing on photo sharing server 106, may cause the photo sharing webpage 106B executing on computer 114 to upload the transferred photographs via the communication network 101 to the photo database 108.

The photo sharing service 106A may notify the subscribers that the viewpoint generation engine 102 uses information associated with uploaded photographs to identify the geographic location of viewpoints. A subscriber may consent to the use of the information associated with the uploaded photographs to identify the geographic location of viewpoints. A subscriber may indicate his consent via the webpage 106A. The photographs and information associated with the photographs may be encrypted before the photographs and information associated with the photographs are stored in the photo database 108. The photo sharing service 106A may periodically seek a subscribers consent for the continuing use of his uploaded photographs. A subscriber may also initiate a revocation of a previously consented use of his photographs.

FIG. 1B illustrates example data structures 130 and 138 corresponding to photographs 108A stored at the photo database 108. The computing device 110 and the camera 112 may store metadata associated with the captured photograph 108A in the several data fields of the data structures 130 and 138. The viewpoint generation engine 102 may utilize the metadata stored in the several data fields to identify one or more viewpoints for the POI 122, for example. The viewpoint generation engine 102 may also identify a geographic location for each of the identified viewpoints.

In one example, a data field 132 may include a time when a computing device captured the photograph. In another example, the subscriber of the photo sharing service 106A may update the photograph capture time data field 132 with a time that approximately corresponds to the capture time of the photograph. In one scenario, the photo sharing service 106A may allow a subscriber to update the photograph capture time data field 132 after the system 100 stores the photograph 108A at the photo database 108. The photograph capture device 110 equipped with a GPS receiver may store latitude and longitude, map coordinates, and other information corresponding to the approximate geographic location of the photograph capture device 110 when it captured the photograph 108A in a photograph location data field 134, 142.

The data structure 130 may also include photograph digital data 136 corresponding to the digital data that comprises the captured photograph. For example, the data 136 may include pixels or other known data elements that are physical points in a raster image captured by the computing device 120, 112, etc. The data 136 may also include the smallest, addressable elements in a computing device that is configured to display the data (i.e., the smallest, controllable element of a digital photograph represented on a screen of the computing device 112, 120). The photograph digital data 136 may conform to one or more standards including JPEG, BMP, TIFF, etc. In some instances the photograph digital data 136 may conform to a proprietary standard. In instances where the photo sharing service 106A utilizes the data structure 138, the photo sharing service 106A may store a reference 144 to the uploaded photograph 108A. The photograph digital data 136 may include a digital representation of an image corresponding to one or more physical objects.

Additionally, in some implementations, the viewpoint generation engine 102 may include instructions to determine different viewpoint(s) for a POI based on the time of day 132, 140 when a device captured the photographs in a cluster of multiple photographs. In this implementation, the viewpoint generation engine 102 may utilize data in the photograph capture time data field 132, 140 in conjunction with data in the photograph location data field 134, 142 to identify viewpoints for a POI and the geographic locations of the viewpoints. For example, the viewpoint generation engine 102 may include instructions to identify a set of photographs which include the POI as a subject. The viewpoint generation engine 102 may further include instructions to filter the set of photographs to identify photographs with a photograph capture time data field including data corresponding to a range of times (for example, 9:00 AM-12:00 PM). The viewpoint generation engine 102 may also include instructions to identify clusters of photographs from the filtered set of photographs. In this example, the viewpoint generation engine 102 instructions may cause the system 100 to identify clusters of photographs by utilizing the data from the photograph location data field 134, 142 of the filtered set of photographs to determine spatial relationships between the photograph locations of the filtered set of photographs and the POI. Finally, the viewpoint generation engine 102 may include instructions to determine the geographic location of a viewpoint from the attributes of the photographs in a cluster.

The viewpoint generation engine 102 may include instructions to retrieve geographic location information (e.g., map coordinates, latitude and longitude values, triangulation data, etc.) for the POI 122 from a location database 124. The viewpoint generation engine 102 instructions may cause the processor of the server 104 to execute instructions that cause the transmission of the geographic location information for the POI 122 and dimensions of a search area surrounding the POI 122 to the photo sharing server 106. The photo sharing server 106 may include instructions to retrieve photographs 108A with geographic location information within the search area from the photo database 108 and to transmit the photographs to the viewpoint generation engine 102. In one scenario, the photo sharing server 106 instructions may utilize location data stored in data structures 130, 138 to determine if a photograph associated with the data structure 130, 138 is located within the search area. For example, the photo sharing server 106 may execute instructions to utilize the data stored in the photograph location data field 134, 142 and determine the distance of the photograph location from the POI 122, for example. The photo sharing server 106 may also include instructions to determine if this distance is within the specified search area. In another scenario, the viewpoint generation engine 102 may execute instructions to communicate directly with the photo database 108 and to retrieve photographs within a configurable threshold proximity or search area of the geographic location of POI 122.

The viewpoint generation engine 102 may also execute instructions to analyze the retrieved photographs and photograph digital data 136 to determine if the POI 122 is represented within the data 136 captured in the photograph 108A. In determining the geographic location of viewpoints corresponding to the POI 122, the viewpoint generation engine 102 may utilize the set of photographs that include the POI 122 as subject data of the captured image.

As previously discussed, the viewpoint generation engine 102 may include instructions that when executed by a processor may cause the viewpoint generation engine 102 to analyze the relationship between the geographic position information of each photograph and the POI 122 to identify one or more clusters of photographs stored in the database 108. The viewpoint generation engine 102 may implement several algorithms to identify one or more clusters of photographs. Generally, a cluster is a collection of objects in which each object bears a relationship to the other objects. For example, in the case of photographs, a group of photographs captured from approximately the same geographic locations may comprise a cluster. Examples of cluster algorithms include centroid-based clustering, density-based clustering, distribution based clustering, etc. Based on the analysis of the clusters, the viewpoint generation engine 102 may identify one or more viewpoints for the POI 122. In some instances, the viewpoint generation engine 102 may execute instructions to generate data structures to store the information corresponding to the identified viewpoints. The data structures may be stored at the map database 116 or another component of the viewpoint generation system 100. In other instances, the viewpoint generation engine 102 may execute instructions to annotate the digital maps stored at the map database 116 with information corresponding to the identified viewpoints. In still other instances, the viewpoint generation engine 102 may transmit the viewpoint information to the map server 118.

A user of the computing device 120 may cause the map server 118 to execute instructions to transmit digital map data corresponding to the geographic location of the POI 122. The transmitted digital map data may include information corresponding to the viewpoints identified by the viewpoint generation engine 102. A mapping application executing on the computing device 120 may execute instructions to render an image of the map at the display of the computing device 120. In one embodiment, a web browser executing on the computing device 120 may display the map image in a web browser executing on the device. In another embodiment, a mapping application executing on the computing device 120 may cause a processor of the computing device 120 to execute one or more instructions to display the map image.

FIG. 1C illustrates an example map 150 annotated with viewpoint markers 152, 154 and 156. The viewpoint generation system 100 (FIG. 1A) may identify the cartographic location of the viewpoint markers 152, 154, and 156 and annotate the map 150. A web browser 151 executing on the computing device 120 of FIG. 1A may display the map 150. The computing device 120 may receive digital data from the map server 118 via the communication network 101 to generate the map 150. The digital data utilized to generate the map 150 may include the information corresponding to the viewpoint markers 152, 154 and 156. The map 150 may display thumbnails (162, 164, and 166 for example) for photographs 108A. The map 150 may display the thumbnails at geographic locations corresponding to each location of the photographs 108A. The viewpoint generation system 100 may identify photographs that include POI 158 or POI 160 alone or both POI 158 and POI 160 as subjects. The spatial location of the viewpoint markers 152 and 154 may correspond to cartographic locations identified by the viewpoint generation system 100. An observer may position himself at the cartographic locations to view or capture a photograph of the various POIs. Similarly, the geographic location of viewpoint markers 154 and 156 may correspond to vantage points for viewing the POI

The viewpoint generation system 100 may identify clusters 168, 170 and 172 of photographs based on attributes of the POI photographs. The viewpoint generation engine 102 may execute an instruction to cause one or more clustering algorithms to identify clusters 168, 170 and 172 (depicted with dashed circles). In one example, a clustering algorithm may utilize the POI photograph attributes to analyze spatial and temporal relationships between the POI photographs in the set of photographs, and the location of the POI. Examples of photograph attributes include the time of capture of the photograph and the geographic location of the photograph capture device when the photograph was captured. The POI photograph attributes may correspond to the data stored in the data fields of the data structures 130 and 138 (FIG. 1B). The viewpoint generation system 100 may identify geographic or cartographic locations for the viewpoint markers 152, 154, and 156 by analyzing attributes of each of the POI photographs in each of the clusters 168, 170 and 172, respectively. By way of example and without any limitation, the geographic location of viewpoint markers 152, 154, and 156 may correspond to the mean or average of the geographic coordinates of each of the POI photographs in clusters 168, 170 and 172, respectively. In another example, the geographic coordinates of the viewpoint marker 152 may correspond to the “centroid” of a two-dimensional shape, the contours of which enclose all of the POI photographs in the cluster 168. A two-dimensional shape may be a regular shape such as a square or a circle or a two-dimensional shape may be an irregular shape. Generally, the centroid of a two-dimensional shape corresponds to the geometric center of the two-dimensional shape.

In some instances, POI photographs in a cluster may include two or more POI as subjects. For example, POI photographs in cluster 170 include both POI 158 and POI 160 as subjects. In these instances, the viewpoint generation system 100 may modify the visual attributes of the viewpoint markers to communicate this information to a user. For example, viewpoint marker 152 corresponding to POI 158 is transparent whereas viewpoint marker 156, corresponding to POI 160, is “filled”. In this example, the viewpoint marker 154 is “partially filled” because the viewpoint generation system 100 determined that viewpoint marker 154 corresponded to viewpoints for both POI 158 and POI 160.

As previously discussed, the computing device 120 receives digital map data with viewpoint markers 152, 154 and 156 from the map server 118. In one scenario, the map server 118 may transmit digital map data in a suitable vector graphics format, for example scalable vector graphics (SVG). In this scenario, the digital map data may be received as several “map tiles.” The computing device 120 may execute an instruction to apply suitable vector graphic algorithms to the map tiles to generate or render an image of the map. The map server 118 may assign separate topographical features of the map to different “layers.” For example, the server may transmit traffic information and viewpoint information as a separate layers. A user of computing device 120 may cause the computing device to render and display particular layers of the map data at the computing device 120. In one example, the map server may transmit the viewpoint marker information and the thumbnails of the photographs as separate layers of the digital map data. The user may “check” the checkbox 176. In response, the processor of the computing device 120 may execute an instruction to render and display the viewpoint markers 152, 154 and 156. By checking the checkbox 178, a user may cause the computing device 120 to render and display thumbnails 162 and 166, for example.

In some instances, the user of the computing device 120 may view the viewpoint-annotated map 150 and choose to proceed directly to the viewpoint indicated by marker 152 to view and photograph the POI 158 before travelling to the second viewpoint 156 corresponding to the second POI 160, to view and photograph the POI 160. Alternatively, the user of the computing device 120 may proceed to the viewpoint indicated by marker 154 to view and photograph both the POI 158 and 160. Simultaneously, based on the time of day the person may chose to completely avoid going to a viewpoint if the person possesses a priori knowledge that the viewpoint is not suitable for viewing the POI at that time of the day. Tourists visiting a geographic location that includes several POI may plan their itinerary to view and photograph each of the POI in the geographic location.

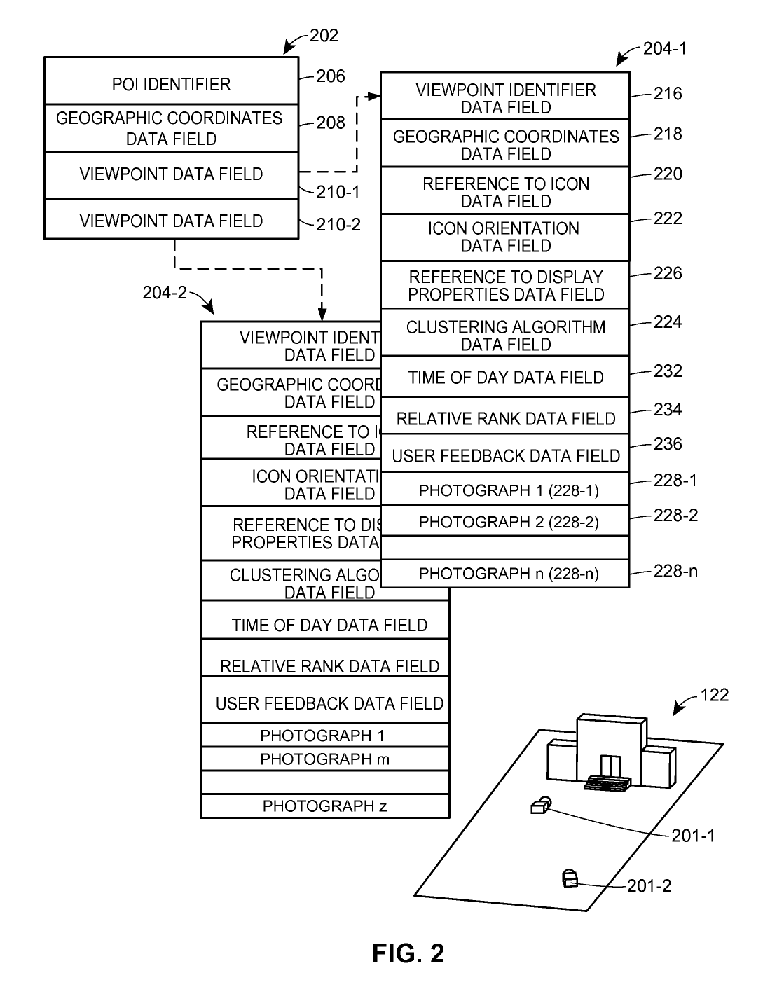

FIG. 2 is an illustration of example data structures which may be created by the system 100 to store or represent various data as it is processed by the system 100. The viewpoint generation system 100 of FIG. 1A may store information corresponding to viewpoint 201-1 and 201-2 for the POI 122 in the data structures of FIG. 2. The map server of 118 of FIG. 1A may utilize the information stored in the data structures 202, 204-1 and 204-2 to generate vector graphics data for viewpoint markers 152 and 154 (FIG. 1C) corresponding to viewpoints 201-1 and 201-2. As previously discussed, the map server 118 may transmit the generated vector graphics data when a user requests digital map data for the geographic location corresponding to the POI 122. In one scenario, the viewpoint generation engine 102 of FIG. 1A may generate the POI data structure 202 in response to receiving a request to identify a viewpoint for the POI 122 from photograph attributes (See FIG. 1B, 130 138) captured in the vicinity of the POI 122. As an example, based on the clustering analyses of POI photographs 201, the viewpoint generation engine 102 may identify two clusters of photographs for the same POI. Subsequently, the viewpoint generation engine 102 may identify unique viewpoints 201-1 and 201-2 from each cluster of photographs. The viewpoint generation engine 102 may generate the viewpoint marker data structures 204-1 and 204-2 for the two identified viewpoints, respectively. A viewpoint marker data structure may store the information for an identified viewpoint. The viewpoint generation engine 102 may execute an instruction to associate each of the viewpoint marker data structures 204-1 and 204-2 with the POI data structure 202. The viewpoint generation engine 102 may store the data structures 202, 204-1 and 204-2 at the map database 116 of FIG. 1A.

The viewpoint generation engine 102 may utilize the several data fields that comprise the POI data structure 202 to store information relevant to the POI 122. By way of example and not as a limitation, relevant information may include a POI identifier 206, POI geographic location information 208, and references 210-1, 210-2 to data structures 204-1, 204-2 that include information for viewpoints identified for the POI, as described herein. The POI data structure 202 may include a geographic coordinates data field 208. The viewpoint generation system 100 may store, for example, latitude and longitude, map coordinates, and other information corresponding to the approximate geographic location of the POI 122 in the geographic coordinates data field 208. In this example, the POI data structure 202 also includes a POI identifier data field 206. The viewpoint generation system 100 may store any unique value that enables electronic searching and retrieval of the POI data structure 202 in the POI identifier data field 206. In one implementation, the viewpoint generation system 100 may store a concatenated value of the latitude and longitude information corresponding to the geographic location of the POI in the POI identifier data field 206.

The POI data structure 202 may include one more viewpoint data fields (e.g., 210-1, 210-2). The viewpoint generation system 100 may store a reference to a data structure (e.g., 204-1, 204-2) that includes information for a viewpoint corresponding to the POI 122 in the viewpoint data fields 210-1, 201-2. By way of example and without any limitation, the POI data structure 202 illustrated in FIG. 2 may include viewpoint data fields 210-1 and 210-2. In this example, the viewpoint generation system 100 may store a reference to the viewpoint marker data structure 204-1 and 204-2 in the viewpoint data field 210-1 and viewpoint data field 210-2, respectively. Of course, for each additional viewpoint identified for the POI 122, the viewpoint generation system 100 may generate a viewpoint marker data structure and insert an additional viewpoint data field into the POI data structure 202. The viewpoint generation system 100 may store a reference to the generated viewpoint marker data structure in the inserted data field.

The viewpoint generation engine 102 may execute an instruction to assign a unique value to the viewpoint marker data structure 204-1. The viewpoint generation engine 102 may store the unique value in the viewpoint identifier data field 216 and the viewpoint data field 210-1 of the POI data structure 202.

A mapping application executing at the computing device 120, for example, may utilize the information stored in POI identifier data field 206 of the POI 122 as an index or primary key to retrieve the POI data structure 202 from the map database 116 of FIG. 2. The mapping application may then retrieve the viewpoint marker data structure 204-1 and 204-2 by utilizing the reference information stored in the viewpoint data fields 210-1 and 210-2 of the POI data structure 202, respectively. The mapping application may render the viewpoint markers based on information stored in the viewpoint marker data structure 204-1 and 204-2 when displaying a digital map at the computing device 120.

The viewpoint generation engine 102 may store approximate geographic coordinates corresponding to the geographic location of the identified viewpoint in the geographic coordinates data field 218. In an implementation, the viewpoint generation engine 102 may store a reference to data for an icon in the icon identifier data field 220. The processor of the computing device 120 (FIG. 1A, 1C), for example, may cause the execution of an instruction to render an image of the icon at the geographic coordinates corresponding to the geographic location of the identified viewpoint.

Based on the spatial relationship between the location of the viewpoint and the POI 122, the viewpoint generation engine 102 may determine an optimal angle for viewing the POI 122 from the viewpoint. The system 100 may store information for the viewing angle in an icon orientation data field 222. By way of example and without limitation, viewing angle information stored in the icon orientation data field 222 may include polar, Cartesian, UTM, UPS, stereographic, geodetic, geostationary, or any other type of coordinates. As an example of the system 100 using polar coordinates, if the viewpoint generation engine 102 determines that the identified viewpoint is southwest of the POI at a distance of 1000 meters, the viewpoint generation engine 102 may store the tuple (1000, 225) in the icon orientation data field 222 where the value “1000” represents the distance from the POI and the value “225” represents the viewing angle in degrees from north around the POI. Alternatively, if the viewpoint generation engine 102 determines that the identified viewpoint is northeast of the POI at a distance of 600 meters, the viewpoint generation engine 102 may a store the tuple (600, 45) in the icon orientation data field 222. When rendering an image of a digital map that includes the viewpoint and the POI, a mapping application may utilize the information stored in the icon orientation data field 222 to orient the image of a viewpoint icon to point in the general direction of the POI. A user may utilize the orientation of the viewpoint icon to appropriately position herself with respect to the POI in the real world.

The viewpoint generation system 100 may utilize any one of the previously identified algorithms to identify a “cluster” of photographs from among the POI photographs. In one instance, a cluster algorithm may use a time of photograph capture 132 (FIG. 1B) and the photograph location 134 to identify a cluster of POI photographs. The cluster algorithm 308A may execute on the server 104 or computing device 120, for example. In some instances, the cluster algorithm may identify clusters based on one or more of the attributes (primary attribute) and utilize the other attributes (secondary attributes) to filter the photographs in a cluster. For example, the cluster algorithm may use photograph locations as a primary attribute to identify clusters of photographs based on their spatial relationship to each other. Subsequently, the cluster algorithm may use the time of capture of the photographs in the cluster to identify a temporal cluster. Further, having identified a cluster of photographs, the viewpoint generation system 100 may apply one or more statistical methods to the cluster of photographs to determine the geographic coordinates of a viewpoint for the POI that is the subject of each photograph in the cluster. The viewpoint generation engine 102 may store an indication of the particular clustering algorithm utilized to identify the viewpoint in the clustering algorithm data field 224.

The viewpoint marker data structure 204-1 may include one or more photograph reference data fields 228-1 . . . 228-n. The viewpoint generation engine 102 may store a reference to each of the photographs utilized by the clustering algorithm to identify the viewpoint 201-1. In one implementation, a reference to a photograph 108A may include a link to the storage location of the photograph at the photo database 108 depicted in FIG. 1. A viewpoint may thus be linked with the photographs that also determine the viewpoint. In one scenario, a mapping application may utilize the references to the photographs stored in photograph reference data fields 228-1 . . . 228-n to retrieve the photographs when, for example, a user electronically interacts with the viewpoint marker 201-1 displayed on an image of the digital map. The mapping application may then display the retrieved photographs.

The viewpoint generation system 100 may also modify the temporal and/or visual appearance of a POI icon to convey additional information to a viewer of the map. For example, the viewpoint generation engine 102 may store an indication in the time of day data field 232 corresponding to a range of photograph capture times in the cluster. A mapping application executing on a computing device 120 may utilize the indication in the time of day data field 232 in conjunction with the instantaneous time to determine if the viewpoint should be displayed to a user. For example, if the data in the time of day data field 232 indicates that the photographs 228-1 . . . 228-n were captured between 4 pm and 7 pm, the map rendering engine may display the icon of the viewpoint only when a viewer requests the digital map between the hours of 4 pm and 7 pm. In further embodiments, the map rendering engine may display the icon of the viewpoint when a viewer requests viewpoints for a time of day corresponding to the viewpoint time range.

Separately, viewers of the digital map may convey their opinion or rating of the location of the viewpoint as determined by the viewpoint generation engine 102. For example, by utilizing GPS-enabled cellular smart phones, viewers of the digital map may transmit or report their location information (i.e., a “check in” action using social media applications) when they arrive at the geographic location that approximately corresponds to the geographic location of the viewpoint. Users may utilize one of several available services to transmit their approximate location information. The viewpoint generation engine 102 may receive an indication each time a viewer “checks in” at a location approximately corresponding to the viewpoint 201-1. The viewpoint generation engine 102 may aggregate the received indications and associate them with the identified viewpoint by storing the aggregation in the user feedback data field 236 of the viewpoint marker data structure 204-1 structure. In an embodiment, the viewpoint generation engine 102 may receive an anonymous “check-in” indication. For example, the indication may not be associated with any information that would allow for the identification of the user. In some other embodiments, the viewpoint generation engine 102 may notify a user that her “check-in” information is being recorded or stored. As previously discussed, a user may choose to opt-out from the tracking of his or her “check-in” information. In these embodiments, the viewpoint generation engine 102 may make the indication anonymous by stripping away any information that would allow for the identification of the user.

As previously mentioned, the viewpoint generation engine 102 may identify two viewpoints 201-1 and 201-2 for the POI 122 based on clustering photographs in the vicinity of the POI 122. The viewpoint generation engine 102 may implement methods to “rank” the two viewpoints 201-1 and 201-2. The viewpoint generation engine 102 may store a relative rank for each of the viewpoints 201-1 and 201-2 in the relative rank data field 234 of the viewpoint marker data structure 204-1 and 204-2, respectively. The viewpoint generation engine 102 may utilize several methods to determine the relative ranks of the viewpoints 201-1 and 201-2. For example, a viewpoint generation engine may utilize information stored in the user feedback data field 236 of the viewpoint data structures 204-1 and 204-2 to rank the viewpoints 201-1 and 201-2, respectively. The viewpoint generation engine 102 may implement several methods to determine the relative rank order of viewpoints. As an example, the viewpoint generation engine 102 may identity the viewpoint 201-1 from a cluster of twenty photographs. Also, the viewpoint generation engine 102 may determine that a size of the cluster corresponds to ten square meters. The viewpoint generation engine 102 may also identity the viewpoint 201-2 from a cluster having a cluster area of three square meters that includes fifteen photographs. The viewpoint generation engine 102 may also compute a cluster density of the photographs associated with a viewpoint. In some embodiments, the cluster density may correspond to a ratio between the number of photographs in the cluster and the area of the cluster. In this example, the viewpoint generation engine 102 may determine that the viewpoint 201-1 has a photograph density of two and that the viewpoint 201-2 has a photograph density of three. In one implementation, the viewpoint generation engine 102 may rank the viewpoint 201-1 higher than the viewpoint 201-2 because the viewpoint 201-1 engine 102 determined the viewpoint from a larger number of photographs (twenty>fifteen). In another implementation, the viewpoint generation engine 102 may rank the viewpoint 201-2 higher than the viewpoint 201-1 because the viewpoint 201-2 had a higher photograph density than the viewpoint 201-1 (three>two). Based on the relative ranks of the viewpoints, a mapping application may display a higher-ranking viewpoint indicator more prominently than a lower-ranking viewpoint indicator.

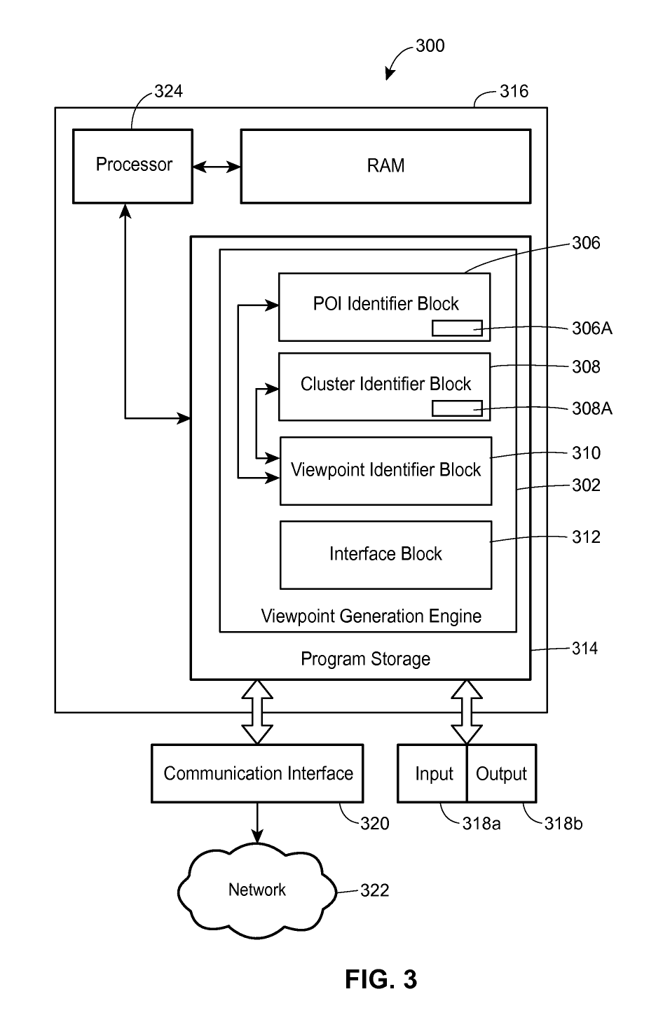

FIG. 3 is a block diagram of an example computing device 300 which implements a viewpoint generation engine 302 to automatically identify viewpoints for a POI. As previously discussed, the viewpoint generation engine 302 automatically identifies viewpoints for a POI by analyzing the attributes of photographs that were captured in the vicinity of a POI. In the embodiment of FIG. 3, the viewpoint generation system 100 stores the viewpoint generation engine 302 as computer-readable instructions (software instructions) on a storage medium (or “program storage”) 264 that may be tangible and non-transitory. The instructions may include instructions to retrieve photographs 108A, for example, from the photo database 108, instructions to analyze photograph data 156 to determine if a POI is a subject of the photograph, instructions to analyze photograph attributes 152, 154 (FIG. 1B), instructions to determine one or more viewpoint cartographic locations from the photograph attributes 152 154 for the POI, and instructions to annotate map data with the one or more viewpoint icons at the one or more viewpoint cartographic locations. In some embodiments, the viewpoint generation engine 302 includes a POI identifier block 306, a cluster identifier block 308, a viewpoint identifier block 310, and an interface block 312. The computing device 300 includes random access memory 316 and a processor 324. The processor 324 may read instructions corresponding to the viewpoint generation engine 302 from the memory and execute the instructions to retrieve photographs 108a, 108b, etc., from the photo database 108, to cause the analysis of photograph data 156 to determine if a POI is a subject of the photograph, to cause the analysis of photograph attributes 152, 154 (FIG. 1B), to determine one or more viewpoint cartographic locations from the photograph attributes 152, 154 for the POI, and to annotate map data with the one or more viewpoint icons at the one or more viewpoint cartographic locations. In some implementations, the processor 274 may be a multi-core processor.

The viewpoint generation engine 302 may receive input from an input sub-system 318a which is communicatively coupled to the computing device 300. The input sub-system 318a generally may include one or more of a pointing device such as a mouse, a keyboard, a touch screen, a trackball device, a digitizing tablet, etc. The viewpoint generation engine 302 provides output to a user via the output sub-system 318b. The output sub-system 318b may include a video monitor, a liquid crystal display (LCD) screen, etc. The viewpoint generation engine 302 may also be communicatively coupled to a communication interface 320. The communication interface 320 generally may include a wired ethernet communication link, a wireless ethernet communication link, etc. The viewpoint generation engine 320 may communicate with one or more remote computing devices (not shown) disposed on a network 322 via the communication interface 320. In an example, the computing device 300 corresponds to the server 104 of FIG. 1A. The network 322 may also correspond to the communication network 101 of FIG. 1A.

By way of example and without limitation, the interface block 312 may enable the POI identifier block 306, the cluster identifier block 308, and the viewpoint identifier block 310 to communicate with resources located on the network 322. The interface block 312 may also programmatically couple the POI identifier block 306, the cluster identifier block 308 and the viewpoint identifier block 310 with each other as well as with the computing resources including the input sub-system 318b and the output sub-system 318b.

In one example, the POI identifier block 306 may utilize functional modules in the interface block 312 to communicate with the photo sharing service 106A on the photo sharing server 106 (FIG. 1) to retrieve photographs 108A stored in the photo database 108. The POI identifier block 306 may analyze the received photographs to identify a set of photographs that includes one or more POIs as the photograph subject. The POI identifier block 306 may cause the processor 324 to execute an instruction to store a list of references corresponding to the set of photographs within a cluster identifier block 308. Referring to FIG. 2, in response to identifying a POI, the POI identifier block 306 may cause the processor 324 to execute an instruction to generate a POI data structure similar to POI data structure 202 (FIG. 2). The POI identifier block 306 may also include an instruction to store information for the identified POI in the generated POI data structure. The cluster identifier block 308 may include instructions that implement one or more clustering algorithms 308A. By utilizing the clustering algorithms 308A, the cluster identifier block 308 may identify one or more clusters of photographs, for example 170, 172, 168 (FIG. 1C) by analyzing the time of capture and the photograph location information for the set of photographs, as described above in relation to FIG. 1C.

The cluster identifier block 308 may cause the processor 324 to execute instructions to store a list of references corresponding to each of the identified clusters of photographs within a viewpoint identifier block 310. The cluster identifier block 308 may generate a viewpoint marker data structure 204-1 (FIG. 2) for each identified cluster of photographs. The cluster identifier block 308 may store references to each of the photographs in the photograph data fields 228-1 . . . 228-n. In this example, the cluster identifier block 308 may cause the processor 274 to execute an instruction to store a list of references corresponding to the generated viewpoint marker data structure within the viewpoint identifier block 310.

The viewpoint identifier block 310 may cause the processor 324 to execute instructions to analyze the photographs in a cluster of photographs to determine a viewpoint. The viewpoint identifier block 310 may store information corresponding to the viewpoint (e.g., geographic coordinates) in the received viewpoint data structure 204-1. The viewpoint identifier block 260 may store information for the identified viewpoints. In one example, the viewpoint identifier block 310 may cause the processor 324 to execute instructions to store data structures comprising information for the identified viewpoints within a map database 116 (FIG. 1A).

The functionality ascribed to the several blocks of the viewpoint generation engine 320 is only illustrative. In other embodiments of the viewpoint generation engine 102 of FIG. 1A, different software architectures may result in functions of the viewpoint generation engine 302 being ascribed to other modules or blocks. In some implementations, the viewpoint generation system 100 may dispose the POI identifier block 306 and the viewpoint identifier block 310 on interconnected devices via the network 322.

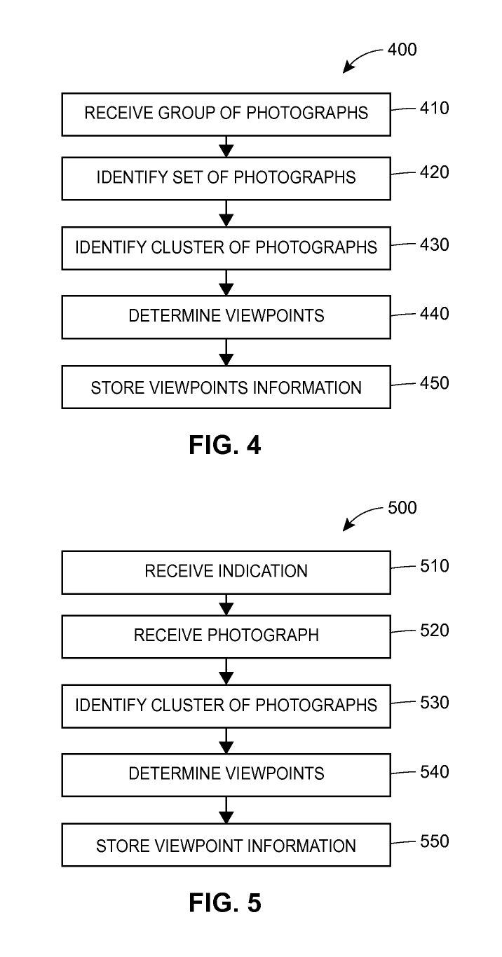

FIG. 4 is a flow diagram of an example method 400 employed by a viewpoint generation engine 102, 302 for identifying one or more viewpoints for a POI based on analyzing photographs captured in the vicinity of the POI that include the POI as a subject. The method 400 may include one or more blocks, modules, functions or routines implemented as computer-executable instructions that are stored in a tangible computer-readable medium and executed using a processor 324.

At block 410, a viewpoint generation engine 102, 302 may receive a group of photographs 108A (FIG. 1A), for example. The engine 102 may receive the photographs in response to the processor 324 executing instructions to cause the viewpoint generation engine 102, 302 to transmit a request for photographs to the photo-sharing server 106. The requested photographs may include a POI at the subject and location data indicating that each photograph was captured within a threshold proximity of a POI and to each other. Depending on the scenario, the engine 102, 302 may receive the photographs in the form of a digital file, a reference to a file stored elsewhere, etc.

At block 420, from the group of photographs received at block 310, the viewpoint generation engine 302 may identify a set of photographs including location data within a threshold proximity of the POI that include photograph digital data 136 representing an image corresponding to the POI as a subject of the photograph. One example, functionality implemented at block 320, may be logically and programmatically ascribed to the POI identifier block 306 of the viewpoint generation engine 302 of FIG. 3. The method implemented at block 420 may utilize image processing software 306A to identify features in the photograph digital data 136 that match unique visual attributes of the POI. On determining that a photograph includes the unique visual attributes of the POI, the method may conclude that the POI is the subject of the digital photograph.

At block 430, the method 400 may analyze the set of photographs identified at block 420 to identify one or more clusters of photographs from the set of photographs. The cluster identifier block 308 of the viewpoint generation engine 302 may implement the functionality included at block 430. The method may utilize clustering algorithms 308A to identify a subset or cluster of photographs from the set of photographs. The photographs in a cluster may include those photographs having one or more of a pre-determined spatial relationship to the POI (i.e., the first threshold proximity as described above) and to each other (i.e., a second threshold proximity). For example, the cluster of photographs may be generally located on the map at a geographic location within the first threshold proximity (i.e., an average distance from the POI for the location data of each digital photograph of the cluster), where the location data for all digital photographs of the cluster is within a second threshold proximity of location data for each photograph of the cluster. For example, a set of photographs including the POI as a subject may be located on the digital map within one hundred meters (i.e., the first threshold proximity) of the POI. Within that set of photographs, a cluster may include those photographs having location data indicating that they were each captured within three meters (i.e., the second threshold proximity) of each other.

Additionally, the photographs in the cluster may also bear a temporal relationship to each other. For example, the system 100 may receive all the photographs in the cluster between a window of a time of day (e.g., three to five p.m., morning, afternoon, evening, etc), a period of a month (e.g., first week, middle of the month, end of the month, etc.), or season of the year (e.g., spring, summer, fall, winter, or refinements of this period), a moon cycle (e.g., full, half, crescent, etc.), during a festival the particular POI or area of the POI is known for (e.g., Oktoberfest, Christmas, New Year's, etc.), or any other type of period or occasion associated with the POI.

At block 440, the method 400 may identify a viewpoint based on analyzing the photograph location data for each photograph in the cluster identified at block 430. Functionality implemented at block 440 may logically correspond to the viewpoint identifier block 310, in an embodiment. In this embodiment, the method 400 may determine an average photograph location for all photographs in the cluster to determine the viewpoint cartographic location. That is, where each photograph of the cluster includes location data indicating that it was captured within the second threshold proximity (described above) to all other photographs of the cluster, the viewpoint cartographic location may approximately correspond to a position on the digital map within the second threshold proximity of the cluster photographs. In another embodiment, the viewpoint cartographic location may correspond to the geometric center of an arbitrary 2-D shape (i.e., the centroid), the contours of which contain the photograph location information for each of the photographs in the cluster.

At block 450, the method 400 may store information corresponding to a viewpoint that was identified at block 440. For example, the viewpoint identifier block 310 may store viewpoint cartographic location information in a map database 116 (FIG. 1A). In an embodiment, the viewpoint identifier block 310 may utilize data structures described with reference to FIG. 2 to aggregate and store information for each of the identified viewpoints.

FIG. 5 is a flow diagram of an example method 500 for updating viewpoint information corresponding to a POI. In an embodiment, the viewpoint generation engine 102, 302, may implement the method 500. At block 510, the method 500 may receive an indication to update viewpoint information for a POI. The photo sharing server 106 (FIG. 1) may transmit the indication. In one example, the photo sharing server 106 may transmit the indication when a subscriber of the photo sharing service 106A uploads a photograph 108A. In this example, the photo sharing server 106 may transmit an indication which includes a reference to the uploaded photograph 108A. In another example, at block 510, the viewpoint generation engine 102, 302 may cause the execution of an instruction which transmits a request to the photo sharing server 106 via the network 322. The request may include a time and POI location information. In response to the request, the photo sharing server 106 may transmit an indication of photographs uploaded after the time specified in the request.

At block 520, the viewpoint location engine 102, 302 may receive the uploaded photograph from the photo sharing server 106. In some instances, the viewpoint generation engine 102, 302 may analyze the metadata fields 130, 138 (FIG. 1B) of the photograph 108A to identify the geographic location of the camera when the photograph was captured. The POI identifier block 306 of the viewpoint generation engine 302 may analyze the photograph to determine if a POI is a subject of the image.

If the POI is the subject of the photograph received at block 520, the viewpoint generation engine 102 or 302 may receive and analyze previously identified viewpoint information for the POI in conjunction with the attributes of the photograph at block 530. In some instances, the viewpoint generation engine 102, 302 may receive data structures 202, 204-1, and 204-2 as previously discussed with respect to FIG. 3 for the previously identified viewpoints 201-1, 201-2 corresponding to the POI 122. The processor 324 may cause the execution of an instruction triggering the cluster identifier block 308 to initiate the process of identifying a new cluster of photographs based on the attributes of received photographs and the information included in the data structures 204-1, 204-2. In one scenario, at block 530, the cluster identifier block 308 may determine that the photograph should be included in a previously identified cluster of photographs 168 (FIG. 1C), for example. In this case, the cluster identifier block 308 may add a photo reference data field 228-n to the previously created viewpoint marker data structure 204-1 associated with the cluster 168 and with viewpoint 201-2 and store a reference to the photograph 108A in the photo reference data field 228-n.

At block 540, the viewpoint generation engine 102, 302 may identify one or more viewpoints. For example, if the cluster identifier block 308 identifies a new cluster of photographs at block 540, the viewpoint identifier block 310 may identify a new viewpoint. If the cluster identifier block 308 identified the photograph as belonging to a previously identified cluster of photographs, the viewpoint identifier block 310 may re-compute the geographic coordinates of the previously identified viewpoint. In some embodiments, attributes of the photographs may change the characteristics of the cluster. For example, the attributes of the photograph may cause the centroid of the cluster to change. In this case, the viewpoint identifier block 310 may determine new geographic coordinates for the viewpoint 201-1. At block 550, the viewpoint identifier block 310 may update data structures 202, 204-1, 204-2 with information corresponding to the updated information. For example, if the geographic coordinates of the viewpoint 201-1 have changed, the viewpoint identifier block 310 may update the geographic coordinates data field 218 of the corresponding viewpoint identifier data structure 204-1 with the new location coordinates. The viewpoint generation engine 302 may then cause the system 100 to store the updated data structures in the map database 116.

In operation, the viewpoint generation system 100 may identify geographic locations for viewpoints in the vicinity of a POI from photographs of the POI. The viewpoint generation system 100 may annotate digital map data with information for the viewpoints. In some instances, the viewpoint generation system 100 annotates the digital map with a viewpoint marker or icon at the geographic coordinates corresponding to the geographic location of the identified viewpoints. Users of the viewpoint generation system 100 may utilize computing devices to receive the map data annotated with the viewpoint information. A user may include the viewpoint information in his itinerary. Over time, as subscribers of photo sharing services 106A upload new photographs, the viewpoint generation system 100 may also dynamically update viewpoint information based on attributes of the new photographs. Separately, the viewpoint generation system 100 may account for feedback received from users and dynamically change the visual attributes and ranking of identified viewpoints.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for the subject matter of the claims through the principles disclosed, herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the subject matter disclosed herein without departing from the spirit and scope defined in the appended claims.

1. A computer-implemented method for annotating digital map data via a computer network, the method comprising:
receiving, via the computer network, a plurality of digital photographs, each digital photograph having a point of interest (POI) as a subject and including location data corresponding to a geographic location of a device that captured the digital photograph;
identifying a set of the plurality of digital photographs, wherein each digital photograph of the set has an identical POI as the subject;
identifying a cluster of digital photographs within the set of digital photographs, each digital photograph of the cluster including location data within a threshold proximity of all other photographs of the cluster; and
annotating the digital map data with a viewpoint icon at a viewpoint cartographic location, wherein the viewpoint cartographic location approximately corresponds to a position on the digital map within the threshold proximity of the location data for all the digital photographs of the cluster.

2. The method of claim 1, wherein identifying the set of the plurality of digital photographs further comprises determining if a capture time for each digital photograph that includes the POI is within a user-selected time period.

3. The computer-implemented method of claim 1, further comprising receiving the plurality of digital photographs in response to transmitting a request via the computer network, wherein the request includes location data for the POI.

4. The computer-implemented method of claim 1, wherein identifying the set of the plurality of digital photographs includes analyzing the subject of each digital photograph to identify one or more visual features of the POI.

5. The computer-implemented method of claim 1, further comprising receiving a user-generated check-in event via the computer network, the check-in event generated by receiving an indication of a geographic location corresponding to the viewpoint cartographic location.

6. The computer-implemented method of claim 1, further comprising:
associating the viewpoint icon with a plurality of photograph references, each of the plurality of references pointing to a respective digital photograph of the set; and
transmitting, via the computer network, each digital photograph of the set in response to a user-generated request received via the computer network, the user-generated request including a reference corresponding to the viewpoint cartographic location.

7. The computer-implemented method of claim 1, wherein annotating the digital map includes generating scalable vector graphics data (SVG), wherein the scalable vector graphics data includes information corresponding to the viewpoint icon at the viewpoint cartographic location.

8. The computer-implemented method of claim 1, further comprising, in response to receiving an indication including a reference to a new digital photograph, the new digital photograph unique from the plurality of digital photographs:
determining a new viewpoint cartographic location based on the location data for each digital photograph of the set and the location data of the new digital photograph; and
annotating the digital map data with the viewpoint icon at the new viewpoint cartographic location.

9. The computer-implemented method of claim 1, further comprising, receiving via the computer network, a user-generated feedback event, the feedback event generated when a user programmatically interacts with the viewpoint icon.

10. A non-transitory tangible computer-readable medium storing instructions thereon for automatically annotating digital map data, wherein the instructions, when executed on a processor, cause the processor to:
receive, via the computer network, a plurality of digital photographs, each digital photograph having one or more physical objects as a subject, and the location data corresponding to a geographic location of a device that captured the digital photograph;
determine a point of interest (POI) for each received digital photograph based on the subject of the digital photograph;
determine a set of the plurality of digital photographs, wherein each digital photograph of the set includes an identical POI as the subject data;
identify a cluster of digital photographs within the set of digital photographs, each digital photograph of the cluster including location data within a threshold proximity of all other photographs of the cluster; and
annotate the digital map data with a viewpoint icon at a viewpoint cartographic location, wherein the viewpoint cartographic location approximately corresponds to a position on the digital map within the threshold proximity of the location data for all the digital photographs of the cluster.

11. The non-transitory tangible computer-readable medium of claim 10, further comprising instructions that, when executed on the processor, cause the processor to:
receive a reference to a new digital photograph, the new digital photograph unique from the plurality of digital photographs;
determine a new viewpoint cartographic location based on the location data for each digital photograph of the set and the location data of the new digital photograph; and
annotate the digital map data with the viewpoint icon at the new viewpoint cartographic location.

12. A computer system for annotating digital map data with a viewpoint icon based on analyzing a plurality of digital photographs received via a computer network, wherein each digital photograph has one or more physical objects as a subject, and including location data corresponding to a geographic location of a device that captured the digital photograph, the system comprising:
a point of interest (POI) identification system including instructions to determine a point of interest (POI) for each digital photograph based on the subject of the digital photograph and to identify a set of the plurality of digital photographs, wherein each digital photograph of the set has an identical POI as the subject;
a cluster identification system including instructions to identify a cluster of digital photographs from the set of the plurality of digital photographs, each digital photograph of the cluster including location data within a threshold proximity of all other photographs of the cluster;
an annotation system including instructions to annotate the digital map data with a viewpoint icon at a viewpoint cartographic location, wherein the viewpoint cartographic location approximately corresponds to a position on the digital map within the threshold proximity of the location data for all the digital photographs of the cluster.

13. The computer system of claim 12, wherein instructions to identify the cluster of digital photographs from the set of the plurality of digital photographs further comprises determining if a capture time for each digital photograph that includes the POI is within a user-selected time period.

14. The computer system of claim 12, wherein the POI identification system further includes instructions to receive the plurality of digital photographs in response to transmitting a request to a remote digital photograph database via the computer network, the request including location data for the POI.

15. The computer system of claim 12, wherein the POI identification system further includes instructions to analyze the subject of each digital photograph to identify one or more visual features of the POI.

16. The computer system of claim 12, wherein the cluster identification system further includes instructions to receive a user-generated check-in event via the computer network, the check-in event generated by receiving an indication from a geographic location corresponding to the viewpoint cartographic location.

17. The computer system of claim 12, wherein the cluster identification system further includes instructions to:
associate the viewpoint icon with a plurality of photograph references, each of the plurality of references pointing to a respective each digital photograph of the cluster; and
transmit, via the computer network, each digital photograph of the cluster in response to a user-generated request received via the computer network, the user-generated request including a reference corresponding to the viewpoint cartographic location.

18. The computer system of claim 12, wherein, in response to receiving an indication including a reference to a new digital photograph, the new digital photograph unique from the plurality of digital photograph, the cluster identification system further includes instructions to determine a new viewpoint cartographic location based on the location data for each digital photograph of the set and the location data of the new digital photograph.

19. The computer system of claim 18, wherein the annotation system further includes instructions to annotate the digital map data with the viewpoint icon at the new viewpoint cartographic location.

20. The computer system of claim 12, wherein the cluster identification system further includes instructions to aggregate user-generated feedback information received via the computer network, the user-generated feedback information generated in response to user interaction with the viewpoint icon.
